(19) United States
(12) Patent Application Publication
(10) Pub. No.: US 2015/0055858 A1
(43) Pub. Date: Feb. 26, 2015

(54) SYSTEMS AND METHODS FOR COLOR RECOGNITION IN COMPUTER VISION SYSTEMS

(71) Applicant: GM GLOBAL TECHNOLOGY OPERATIONS LLC, Detroit, MI (US)

(72) Inventors: MUHAMMAD E. ABDALLAH, ROCHESTER HILLS, MI (US); STEPHEN L. JONES, CLIO, MI (US); SRETEN ZAKULA, WINDSOR (CA)

(21) Appl. No.: 14/333,852

(22) Filed: Jul. 17, 2014

Related U.S. Application Data
(60) Provisional application No. 61/868,175, filed on Aug. 21, 2013.

(51) Int. Cl. G06K 9/46; G06T 5/00

(52) U.S. Cl. CPC G06K 9/4652; G06T 5/00
USPC 382/165

(57) ABSTRACT

A color recognition method includes determining a predefined set of colors within a color space and storing the predefined set of colors in a memory; determining a desired color selected from the predefined set of colors; receiving an image; filtering the image with a processor to produce a filtered image substantially comprising only the predefined set of colors; and determining whether the desired color is present within the image.

### CROSS-REFERENCE TO RELATED APPLICATIONS

This application claims priority to U.S. Provisional Pat. App. No. 61/868,175, filed Aug. 21, 2013, the entire contents of which are hereby incorporated by reference.

### TECHNICAL FIELD

The technical field generally relates to computer vision systems, and more particularly relates to methods and systems for recognizing colors in computer vision systems.

### BACKGROUND

Computer vision systems are employed in a wide range of applications to acquire, process, and apply recognition techniques to images of objects within an environment. In an industrial manufacturing context, for example, computer vision systems are often used to identify components and assemblies (e.g., automotive components) as they move through the manufacturing process.

To assist the computer vision system in recognizing components, color markers may be painted or otherwise applied to small regions of the components. In such cases, however, the applied color markers might exhibit significant color variability caused, for example, by variations in paint thickness, background bleed-through, background color variations, extraneous surface coatings (oil, rust-inhibitors, etc.), surface oxidation and aging, camera white-balance variations, ambient light variation, and the like.

While conventional training and machine learning techniques may be applied to address this undesirable color variability, such methods—which often require one or more supervised training sessions—can be costly and time-consuming. Furthermore, such methods still may not adequately recognize and classify a desirable range of colors.

Accordingly, it is desirable to provide improved methods and systems for determining colors in computer vision systems. Furthermore, other desirable features and characteristics of the present invention will become apparent from the subsequent detailed description and the appended claims, taken in conjunction with the accompanying drawings and the foregoing technical field and background.

### BRIEF SUMMARY

A color recognition method in accordance with one embodiment includes determining a predefined set of colors within a color space and storing the predefined set of colors in a memory; determining a desired color selected from the predefined set of colors; receiving an image; filtering the image with a processor to produce a filtered image substantially comprising only the predefined set of colors; and determining whether the desired color is present within the image.

A color recognition system in accordance with one embodiment includes a camera module configured to produce an image; a classifier filter module configured to receive the image and apply a filter based on predefined set of colors stored in a memory to produce a filtered image; and an image recognition module configured to receive the filtered image and determine whether a desired color selected from the predefined set of colors is within filtered image.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a color recognition system in accordance with various embodiments;

FIG. 2 is a functional block diagram depicting a color recognition system in accordance with various embodiments;

FIGS. 3-4 depict example RBG color spaces suitable for use with various embodiments;

FIGS. 5-6 depict example HSV color spaces suitable for use with various embodiments;

FIG. 7 is a flowchart depicting a color recognition method in accordance with various embodiments; and

FIG. 8 is a flowchart depicting a color recognition method in accordance with the various embodiments.

### DETAILED DESCRIPTION

The subject matter described herein generally refers to an improved color recognition system. As will be discussed in further detail below, the described system is particularly advantageous in that it (1) substantially mimics the way in which humans perceive color, (2) fully covers the selected color space, (3) requires minimal training when utilized in connection with a new application, and (4) utilizes calculations having a relatively low complexity (e.g., multiplications, additions, and/or logical comparisons), such that real-time color recognition may be implemented in existing systems.

The following detailed description is merely exemplary in nature and is not intended to limit the application and use of its embodiments. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and/or memory that executes one or more software or firmware programs, a combinational logic circuit, and/or other suitable components that provide the described functionality.

FIG. 1 is a conceptual block diagram of a color recognition system 100 in accordance with various embodiments. As illustrated, system 100 includes a camera module 101, a classifier filter module 102, and an image recognition module 103. Camera module 101 includes any suitable combination of imaging hardware and software configured to produce an image 110, which might have a variety of compressed or uncompressed formats known in the art (e.g., JPEG, raw, and the like), depending upon the nature of camera module 101.

Classifier filter module 102 includes any suitable combination of hardware and/or software configured to receive image 110 and apply a classifier algorithm to filter the image based on a predefined set of colors (e.g., “blue”, “green”, and the like) and thereby produce a filtered image 112. Thus, while original image 110 will typically include a wide range of colors of different hues, saturation, and values, filtered image 112 will include a reduced set of colors in accordance with the predefined set of colors. Example methods for performing classification and filtering will be described in further detail below.

Recognition module 103 includes any suitable combination of hardware and/or software configured to receive filtered image 112 as well as one or more desired colors 120 and determine whether those desired colors are present within filtered image 112. For example, a particular desired color 120 (which may be selected by an operator or provided automatically) might be “blue”, known to correspond to a particular type of component (e.g., a portion of an automotive powertrain). Based on whether recognition module 103 determines that the desired color “blue” is present within filtered image 112, recognition module 103 produces a result 113 (e.g., a Boolean value) indicative of whether the desired color is present.

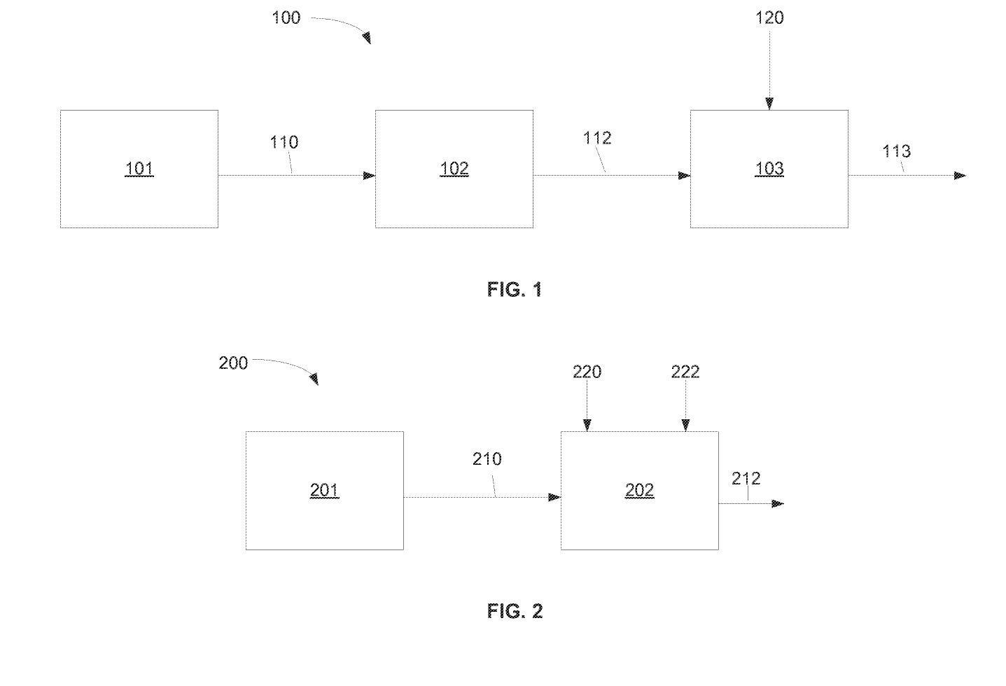

FIG. 2 is a conceptual block diagram of a color recognition system 200 in accordance with another embodiment. In general, the illustrated embodiment is a variation of system 100 (of FIG. 1) in which all or a portion of the functionality of recognition module 103 is incorporated into classifier filter module 102. Thus, as illustrated, system 100 includes a camera module 201 and a classifier module 202. Camera module 201 includes any suitable combination of imaging hardware and software configured to produce an image 210, which might have a variety of compressed or uncompressed formats known in the art.

Classifier module 202 includes any suitable combination of hardware and/or software configured to receive image 210, one or more desired colors 220 as defined above, and apply a classifier algorithm to filter the image based on a predefined set of colors and determine whether those desired colors are present within image 210. Classifier module 202 might also receive information regarding background colors 222 present within image 210 (e.g., gray, black, etc.). Such information may be used to subtract out the background colors 222 to assist in color recognition. Based on whether classifier module 202 determines that one or more of the desired colors 220 are present within image 210, recognition module 103 produces a result 212 (e.g., a Boolean value) indicative of whether the desired color 220 is present.

While the various modules of FIGS. 1 and 2 are illustrated as separate and distinct, the modules might be incorporated into a single physical component. For example, the modules of FIG. 2 might be incorporated into a single, compact physical camera unit such as a programmable “smart camera”, such as the Cognex In-Sight line of products, or the Dalsa BOA line of products. Such cameras are capable of storing the predefined set of colors, the desired colors, and background colors, and capable of producing an output corresponding to result 212.

The various filtering and categorization techniques described above may be performed in the context of a variety of “color modes” and “color spaces” as those terms are known in the art. The following description presents two such methods: one involving an RGB (red, green, blue) color space, and another involving an HSV (hue, saturation, value) color space. It will be appreciated, however, that the present embodiments are not so limited.

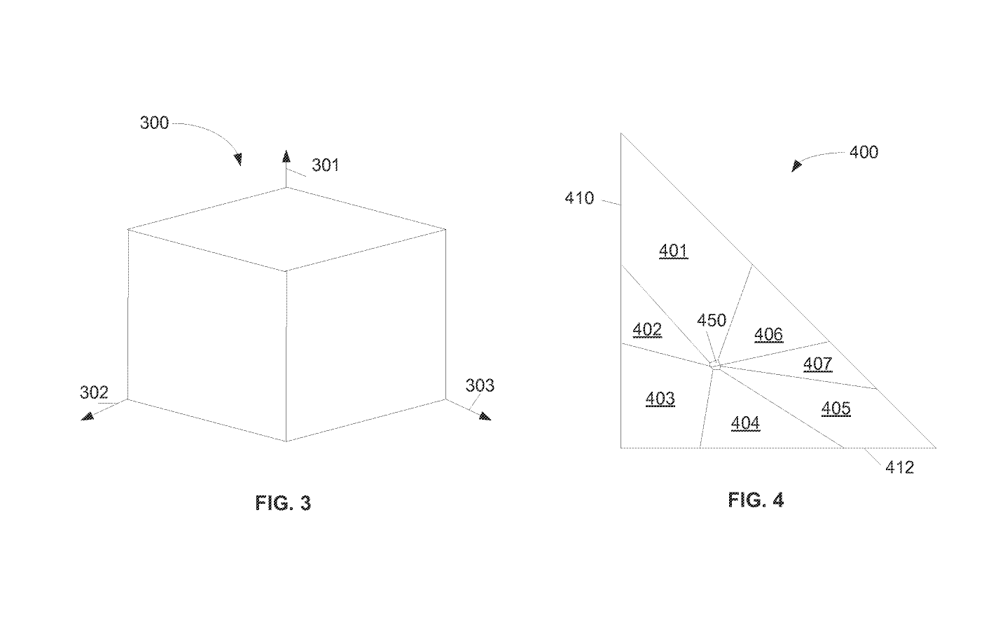

FIGS. 3 and 4 depict exemplary RGB color spaces suitable for use in connection with various embodiments. More particularly, FIG. 3 illustrates a standard Cartesian RGB color space 300 in which colors correspond to points within a cube bounded along R (302), B (301), and G (303) axes. That is, a particular color is characterized by R, G, and B components within space 300, wherein those components might be real numbers (e.g., [0.0, 1.0]), digital discrete values (e.g., [0, 255]), or any other normalized or non-normalized values.

FIG. 4 depicts a triangular RGB color space 400 (i.e., a “chromaticity” or “normalized RBG” space) that represents a transformed version of the RGB color space 300 shown in FIG. 3. Specifically, color space 400 is characterized by an ‘r’ axis 412 and a ‘g’ axis 410, wherein r=R/(R+G+B), g=G/(R+G+B), and color values generally correspond to rotation around a center point 450. In this way, the predefined set of colors (as utilized by the systems illustrated in FIGS. 1 and 2) may be defined to fall within a discrete set of polygonal regions as shown. In one embodiment, for example, region 401 corresponds to ‘green’, region 406 corresponds to ‘yellow’, region 407 corresponds to ‘orange-brown’, region 405 corresponds to ‘red’, region 404 corresponds to ‘purple’, region 403 corresponds to ‘blue’, and region 402 corresponds to ‘cyan’. The definition of the predefined set of colors may be stored in memory, for example, as a look-up table containing geometric characterizations of the various polygonal regions.

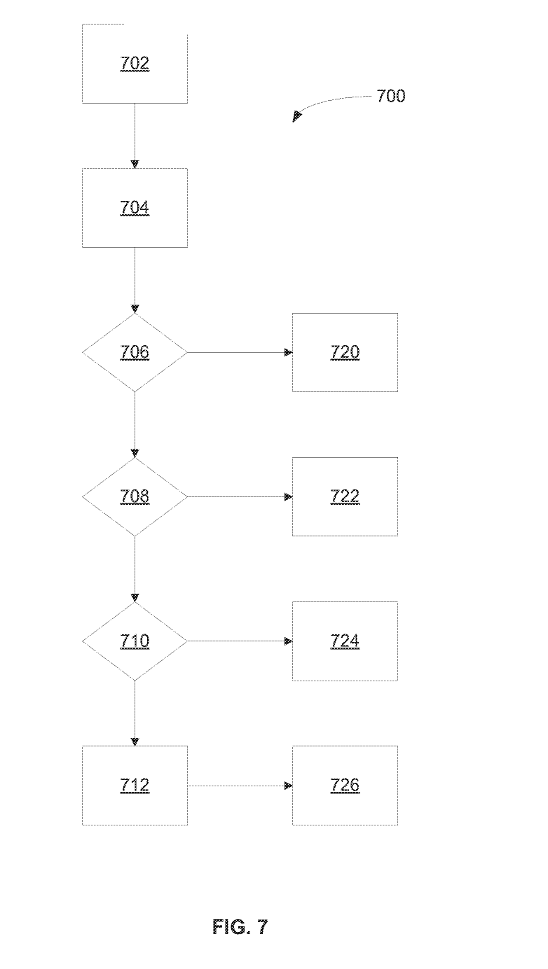

FIG. 7 is a flowchart illustrating an exemplary color recognition method 700 utilizing the RGB color space depicted in FIG. 4. First, a predefined set of colors is determined (702), e.g., as illustrated in FIG. 4, with addition of such colors as ‘black’, ‘white’, and ‘grey’ (which need not be stored within a look-up table). An image is then acquired (704), and is optionally processed (e.g., filtered, smoothed, or the like) to produce a matrix of pixels comprising, for example, normalized R, G, and B values ranging from 0.0 to 1.0. For each of the pixels, the system then determines (706) whether the maximum of R, G, and B is less than a predetermined value a (e.g., about 0.2). If so, the color of that pixel is set to ‘black’ (720). If not, the system proceeds and determines (708) whether the maximum of R, G, and B is greater than a predetermined value (e.g., about 1-α). If so, the color of that pixel is set to ‘white’ (722). If not, the system proceeds and determines (710) whether the difference between the maximum and minimum values (max(R,G,B)−min(R,G,B)) is less than a predetermined value (e.g., about α/2). If so, the color of that pixel is set to ‘grey’ (724). If not, the system determines (712) the appropriate color to select (726) within the set of predefined colors (‘green’, ‘yellow’, etc.) based on its R, G, and B values (e.g., by referring to a look-up table defining those colors). Stated another way, the system first identifies ‘black’, ‘white’, or ‘gray’ in the RGB color space, then identifies the other colors in the same or different color space, where they can be more coherently identifies (e.g., HSV, normalized RGB, or RGB).

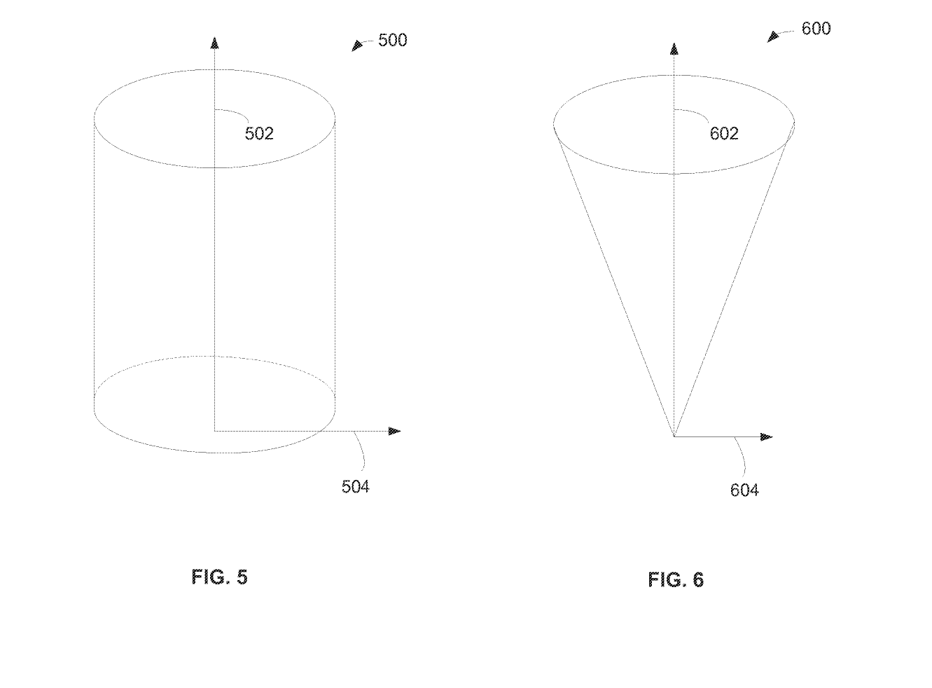

FIGS. 5 and 6 depict exemplary HSV color spaces suitable for use in connection with various embodiments. Specifically, FIG. 5 illustrates a standard cylindrical HSV color space 500 in which colors correspond to points within a cylinder defined by a value V (502), a saturation S (504), and a hue H corresponding to an angle clockwise (right-hand rule) about the V axis (502) with respect to axis 604. That is, a particular color is characterized by H, S, and V components within space 500, wherein those components might be real numbers (e.g., [0.0, 1.0]), digital discrete values (e.g., [0, 255]), or any other normalized or non-normalized values.

FIG. 6 depicts a conical HSV color space 600 that represents a transformed version of the HSV color space 500 shown in FIG. 5. Specifically, color space 600 is characterized by a V axis 602, an S′ axis 604, and an angle about the V axis as defined above, wherein S′=S/V. The predefined set of colors may be then be defined to fall within a discrete set of regions of space 600. The definition of the predefined set of colors may be stored in memory, for example, as a look-up table containing geometric characterizations (e.g., ranges of H, S, and V values) of the various polygonal regions.

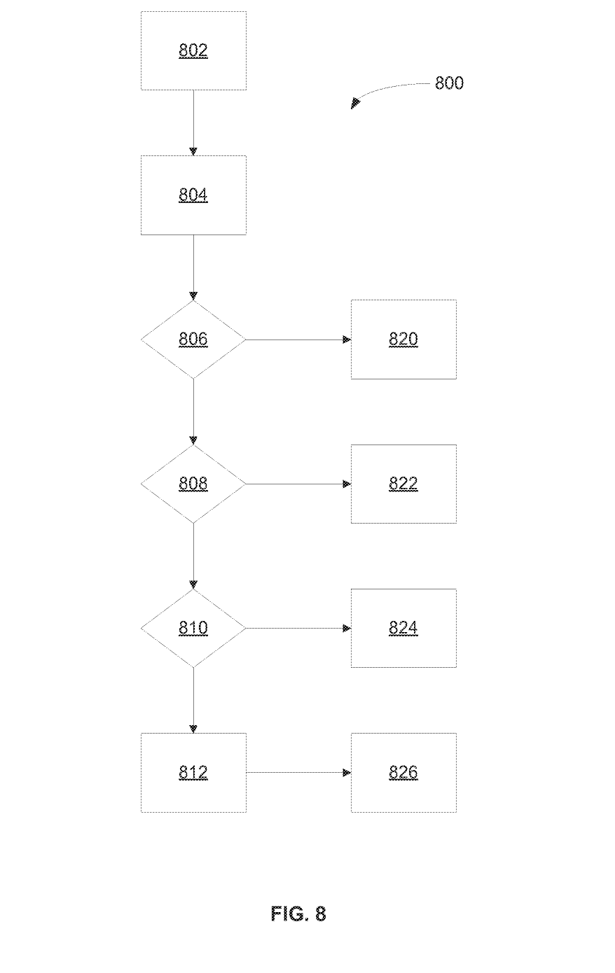

FIG. 8 is a flowchart illustrating an exemplary color recognition method 800 utilizing the HSV color space depicted in FIG. 6. First, a predefined set of colors is determined (802), including, for example, ‘green’, ‘yellow’, ‘orange-brown’, ‘red’, ‘purple’, ‘blue’, and ‘cyan’. Additional colors such as ‘black’, ‘white’, and ‘grey’ are also defined. An image is then acquired (802), and is optionally processed (e.g., filtered, smoothed, or the like) to produce a matrix of pixels comprising, for example, normalized H, S, and V values ranging from 0.0 to 1.0. For each of the pixels, the system then determines (806) whether V is below a predetermined value (e.g, about 0.15). If so, the color of that pixel is set to ‘black’ (820). If not, the system proceeds and determines (808) whether V is greater than a predetermined value (e.g., about 0.9) and S′ is less than a predetermined value (e.g., about 0.15). If so, the color of that pixel is set to ‘white’ (822). If not, the system proceeds and determines (810) whether S′ is less than a predetermined value (e.g., about 0.1). If so, the color of that pixel is set to ‘grey’ (824). If not, the system determines (812) the appropriate color to select (826) within the set of predefined colors (‘green’, ‘yellow’, etc.) based on its H and V values (e.g., by referring to a look-up table defining ranges of those values).

In general, then, a color recognition method in accordance with various embodiments comprises determining a predefined set of colors within a color space and storing the predefined set of colors in a memory. A desired color is then selected from the predefined set of colors. An image is then filtered with a processor to produce a filtered image substantially comprising only the predefined set of colors. The system then determines whether the desired color is present within the image. The predefined set of colors may comprise a look-up table including, for each of the predefined set of colors, a color identification and a corresponding geometrical region within the color space. The color space may, for example, be an HSV color space or an RGB color space.

The embodiments described herein are advantageous in a number of respects. For example, the disclosed color recognition scheme is easy to tune during development and exhibits a low computational complexity compared to prior art methods. Furthermore, the method more closely matches human perception in the sense that the regions of the color spaces may be defined by an individual making an intuitive evaluation of what “blue”, “green”, etc. actually look like to a human. In addition, the color space may be partitioned such that whole color space is used, without overlapping regions of defined colors. As will be appreciated, the exemplary color recognition methods depicted in FIGS. 7 and 8 may be implemented using a wide range of computer languages now known or later developed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A color recognition method comprising:
determining a predefined set of colors within a color space and storing the predefined set of colors in a memory;
determining a desired color selected from the predefined set of colors;
receiving an image;
filtering the image with a processor to produce a filtered image substantially comprising only the predefined set of colors; and
determining whether the desired color is present within the image.

2. The method of claim 1, wherein the predefined set of colors comprises a look-up table including, for each of the predefined set of colors, a color identification and a corresponding geometrical region within the color space.

3. The method of claim 2, wherein each of the corresponding geometrical regions are polygonal.

4. The method of claim 1, wherein the color space is an HSV color space.

5. The method of claim 1, wherein the color space is an RGB color space.

6. The method of claim 5, wherein the color space is chromaticity RGB color space.

7. The method of claim 1, further including identifying at least one of ‘black’, ‘white’, and ‘gray’ pixels in a first color space, and identifying other colors of the predetermined set of colors in a second color space.

8. The method of claim 7, wherein filtering the image includes setting a pixel of the image to ‘black’ in the event that a maximum of a set of values associated with the pixel is less than a first predetermined threshold.

9. The method of claim 8, wherein filtering the image includes setting the pixel of the image to ‘white’ in the event that the maximum of a set of values associated with the pixel is greater than a second predetermined threshold.

10. A color recognition system comprising:
a camera module configured to produce an image;
a classifier filter module configured to receive the image and apply a filter based on predefined set of colors stored in a memory to produce a filtered image; and
an image recognition module configured to receive the filtered image and determine whether a desired color selected from the predefined set of colors is within filtered image.

11. The system of claim 10, wherein the predefined set of colors comprises a look-up table including, for each of the predefined set of colors, a color identification and a corresponding geometrical region within the color space.

12. The system of claim 11, wherein each of the corresponding geometrical regions are polygonal.

13. The system of claim 10, wherein the color space is an HSV color space.

14. The system of claim 10, wherein the color space is an RGB color space.

15. The system of claim 10, wherein the classifier filter module is configured to set a pixel of the image to ‘black’ in the event that a maximum of a set of values associated with the pixel is less than a first predetermined threshold.

16. The system of claim 15, wherein the classifier filter module is configured to set a pixel of the image to ‘white’ in the event that the maximum of a set of values associated with the pixel is greater than a second predetermined threshold.

17. The method of claim 16, wherein the classifier filter module is configured to set the pixel of the image to ‘grey’ in the event that the difference between the minimum and the maximum each of a set of values associated with the pixel is less than a third predetermined threshold.

18. Non-transitory computer-readable media including software instructions configured to cause a processor to carry out the steps of:
determining a predefined set of colors within a color space and storing the predefined set of colors in a memory;
determining a desired color selected from the predefined set of colors;
receiving an image;
filtering the image with a processor to produce a filtered image substantially comprising only the predefined set of colors; and
determining whether the desired color is present within the image.

19. The computer media of claim 18, wherein the predefined set of colors comprises a look-up table including, for each of the predefined set of colors, a color identification and a corresponding geometrical region within the color space.

20. The computer media of claim 19, wherein each of the corresponding geometrical regions are polygonal.
